(19) United States
(12) Patent Application Publication
(10) Pub. No.: US 2013/0039609 A1
(43) Pub. Date: Feb. 14, 2013

(54) HYDRODYNAMIC BEARING ASSEMBLY AND MOTOR INCLUDING THE SAME

(71) Applicants: Young Tae KIM, Seoul (KR); Ju Ho Kim, Seoul (KR)

(72) Inventors: Young Tae KIM, Seoul (KR); Ju Ho Kim, Seoul (KR)

(73) Assignee: Samsung Electro-Mechanics Co., Ltd., Suwon (KR)

(21) Appl. No.: 13/569,544

(22) Filed: Aug. 8, 2012

(30) Foreign Application Priority Data
Aug. 10, 2011 (KR) 10-2011-0079693

(51) Int. Cl. F16C 32/06

(52) U.S. Cl. 384/112; 384/114; 384/107

(57) ABSTRACT

There are provided a hydrodynamic bearing assembly capable of increasing a storage amount of oil and preventing evaporation or leakage of the oil by increasing a length of a sealing part, and a motor including the same. The hydrodynamic bearing assembly includes: a sleeve supporting a shaft such that an upper end of the shaft protrudes upwardly in an axial direction; a sleeve housing provided to enclose an outer peripheral surface of the sleeve, and forming an oil interface between an inner peripheral surface thereof in an outer diameter direction and a main wall part protruding downwardly in the axial direction from a rotor case inserted into the upper end of the shaft; and a cover member provided in lower portions of the shaft and the sleeve and coupled to the sleeve housing while having a clearance therebetween.

### CROSS-REFERENCE TO RELATED APPLICATIONS

This application claims the priority of Korean Patent Application No. 10-2011-0079693 filed on Aug. 10, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same, and more particularly, to a hydrodynamic bearing assembly capable of having an increased oil storage amount and preventing evaporation or leakage of oil by increasing a length of a sealing part, and a motor including the same.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized motor is used.

As a small-sized motor, a hydrodynamic bearing assembly has been used. A shaft, a rotating member of the hydrodynamic bearing assembly, and a sleeve, a fixed member thereof, have oil interposed therebetween, such that the shaft is supported by fluid pressure generated in the oil.

Here, as the sleeve used in the small-sized motor, a sintered sleeve or a processed sleeve may be provided. In order to increase price competitiveness of the motor, a sintered sleeve having a large content of oil has mainly been used.

However, when the sintered sleeve is used, it may have a large content of oil, such that variations in an oil interface are increased due to thermal expansion of the oil. In addition, the sintered sleeve requires a sleeve housing enclosing an outer diameter of the sleeve in order to prevent oil leakage.

An amount of the oil filling a bearing clearance may be rapidly varied due to the oil interface having large variations, in the hydrodynamic bearing assembly using this sintered sleeve, such that there may be an effect on the performance and a lifespan of the motor. Therefore, research into a technology for solving this limitation has been urgently required.

### SUMMARY OF THE INVENTION

An aspect of the present invention provides a hydrodynamic bearing assembly capable of efficiently coping with variations in an oil interface due to a thermal expansion of oil even in the case a sintered sleeve is used therein, and a motor including the same.

According to an aspect of the present invention, there is provided a hydrodynamic bearing assembly including: a sleeve supporting a shaft such that an upper end of the shaft protrudes upwardly in an axial direction; a sleeve housing provided to enclose an outer peripheral surface of the sleeve, and forming an oil interface between an inner peripheral surface thereof in an outer diameter direction and a main wall part protruding downwardly in the axial direction from a rotor case inserted into the upper end of the shaft; and a cover member provided in lower portions of the shaft and the sleeve and coupled to the sleeve housing while having a clearance therebetween.

An upper end portion of the sleeve housing may include a mounting part bent outwardly in the outer diameter direction and then bent upwardly in the axial direction to thereby allow the main wall part to be disposed.

An upper end portion of the sleeve housing may include a step part provided on an inner peripheral surface thereof to thereby allow the main wall part to be disposed.

An outer peripheral surface of main wall part may be tapered such that an interval between the main wall part and the sleeve housing is widened upwardly in the axial direction.

The inner peripheral surface of the sleeve housing facing the main wall part may be tapered such that an interval between the main wall part and the sleeve housing is widened upwardly in the axial direction.

The sleeve housing and the cover member may be formed integrally with each other.

The hydrodynamic bearing assembly may further include a thrust plate mounted on the lower portion of the shaft and facing a lower surface of the sleeve in the axial direction.

A thrust dynamic groove may be provided in an upper surface of the sleeve or in a lower surface of the rotor case facing the sleeve.

A thrust dynamic groove may be provided in a lower surface of the sleeve or in an upper surface of the thrust plate.

The sleeve may be a sintered sleeve.

According to another aspect of the present invention, there is provided a motor including the hydrodynamic bearing assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an embodiment of the present invention;

FIGS. 2A and 2B are schematic cross-sectional views of a hydrodynamic bearing assembly provided in the motor according to the embodiment of the present invention;

FIGS. 3A and 3B are schematic cross-sectional views of a hydrodynamic bearing assembly provided in a motor according to another embodiment of the present invention; and

FIG. 4 is a schematic cross-sectional view of a recording disk driving device in which the motor according to the embodiment of the present invention is mounted.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

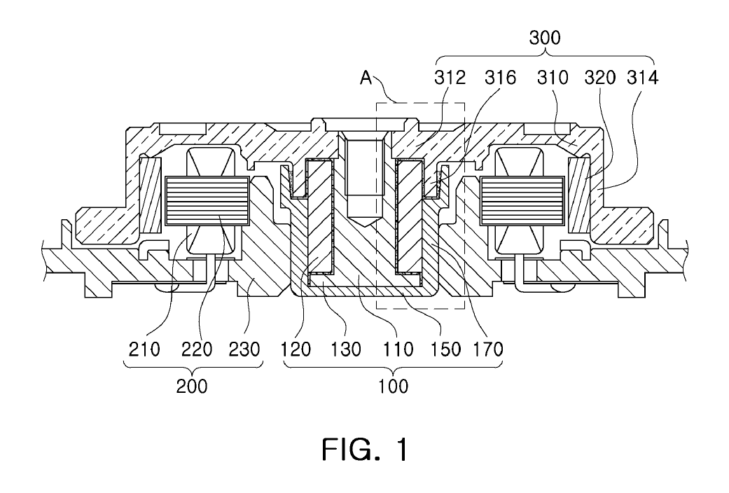

FIG. 1 is a schematic cross-sectional view of a motor according to an embodiment of the present invention.

Referring to FIG. 1, a motor 500 according to an embodiment of the present invention may include a hydrodynamic bearing assembly 100, a stator 200, and a rotor 300.

The hydrodynamic bearing assembly 100 may include a shaft 110, a sleeve 120, a thrust plate 130, a cover member 140, and a sleeve housing 170.

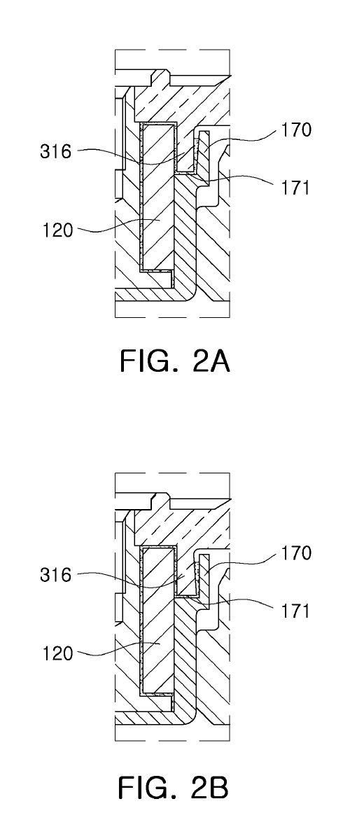

Here, terms with respect to directions will first be defined. As viewed in FIGS. 1 and 2, an axial direction refers to a vertical direction based on the shaft 110 and an outer diameter direction or an inner diameter direction refers to a direction toward an outside edge of the rotor 300 based on the shaft 110 or a direction toward the center of the shaft 110 based on the outside edge of the rotor 300.

The sleeve 120 may support the shaft 110 such that an upper end of the shaft 110 protrudes upwardly in an axial direction. The sleeve 120 may be formed by sintering a Cu—Fe-based alloy powder or a SUS-based powder.

Here, the shaft 110 is inserted into a shaft hole 122 of the sleeve 120 so as to have a micro clearance therebetween. The micro clearance is filled with lubricating fluid, and the rotation of the rotor 300 may be more smoothly supported by a radial dynamic groove formed in at least one of an outer diameter of the shaft 110 and an inner diameter of the sleeve 120.

The radial dynamic groove may be formed in an inner side of the sleeve 120, which is an inner portion of the shaft hole 122 of the sleeve 120, and form pressure such that the shaft 110 is spaced apart from an inner wall of the shaft hole 122 of the sleeve 120 at the time of rotation of the shaft 110.

However, the radial dynamic groove is not limited to being formed in the inner side of the sleeve 120 as described above but may also be formed in an outer diameter portion of the shaft 110. In addition, the number of radial dynamic grooves is not limited.

The sleeve 120 may include a bypass channel (not shown) formed therein so as to communicate between upper and lower portions thereof, such that pressure of lubricating fluid in an inner portion of the hydrodynamic bearing assembly 100 may be dispersed, thereby allowing balance in the pressure of the lubricating fluid to be maintained, and air bubbles, or the like, existing in the inner portion of the hydrodynamic bearing assembly 100 may be transferred so as to be discharged by circulation.

Here, the cover member 150 may be coupled to a lower portion of the sleeve 120 in the axial direction, the cover member 150 being coupled to a sleeve housing 170 to be described below, while having a clearance therebetween, the clearance accommodating the lubricating fluid therein.

The cover member 150 may accommodate the lubricating fluid in the clearance between the cover member 150 and the shaft 110 or the thrust plate 130 to thereby serve as a bearing supporting a lower surface of the shaft 110.

The thrust plate 130 may be disposed downwardly of the sleeve 120 in the axial direction and include a hole formed at the center thereof, the hole having the shaft 110 inserted therein.

In this configuration, the thrust plate 130 may be separately manufactured and then coupled to the shaft 110, but may also be formed integrally with the shaft 110 at the time of manufacturing thereof and may rotate together therewith at the time of the rotation of the shaft 110.

In addition, the thrust plate 130 may include a thrust dynamic groove formed in an upper surface or a lower surface thereof, the thrust dynamic groove providing thrust dynamic pressure to the shaft 110.

The thrust dynamic groove is not limited to being formed in the upper surface or the lower surface of the thrust plate 130 as described above, but may also be formed in a lower surface of the sleeve 120 corresponding to the upper surface of the thrust plate 130 or an upper surface of the cover member 150 corresponding to the lower surface of the thrust plate 130.

The sleeve housing 170, provided so as to enclose the sleeve 120, may be coupled to an outer peripheral surface of the sleeve 120. More specifically, the sleeve 120 may be inserted into an inner peripheral surface of the sleeve housing 170 and be coupled to the sleeve housing 170 by press-fitting or bonding.

Here, the sleeve housing 170 may be a portion of a base member 230 configuring a stator 200 to be described below. However, the sleeve housing 170 will be regarded as a component configuring the hydrodynamic bearing assembly 100 in order to describe a coupling relationship between the sleeve 120 and the sleeve housing 170.

The sleeve housing 170 may be coupled to the outer peripheral surface of the sleeve 120 containing oil to thereby prevent leakage of the oil.

In addition, the sleeve housing 170 may include the cover member 150 coupled thereto at a lower end thereof, while having a clearance from the thrust plate 130, the clearance accommodating the lubricating fluid therein.

The cover member 150 may accommodate the lubricating fluid in the clearance between the cover member 150 and the shaft 110 or the thrust plate 130 to thereby serve as a bearing supporting the lower surface of the shaft 110.

Here, the cover member 150 may be manufactured as a separate member and then coupled to the sleeve housing 170 by press-fitting or an adhesive. In addition, the cover member 150 may be formed integrally with the sleeve housing 170 and be manufactured in various methods such as a pressing method, a casting method, or the like.

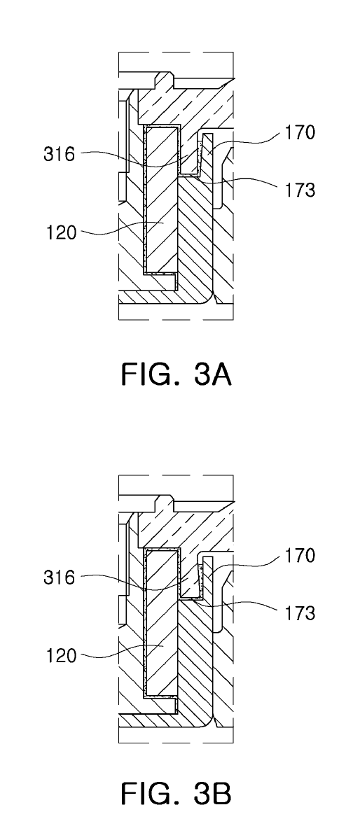

Furthermore, according to the embodiment of the present invention, a sealing part in which an oil interface is formed is provided between an outer peripheral surface of a main wall part 316 provided in a rotor case 310 and the inner peripheral surface of the sleeve housing 170. A detailed description of the sealing part will be provided below with reference to FIGS. 2 and 3.

The rotor 300, a rotational structure provided to be rotatable with respect to the stator 200, may include a rotor case 310 having an annular ring shaped magnet 320 provided on an outer peripheral surface thereof, the magnet corresponding to a core 220 while having a predetermined interval therebetween.

In addition, as the magnet 320, a permanent magnet generating magnetic force having a predetermined strength by alternately magnetizing an N pole and an S pole thereof in a circumferential direction may be used.

Here, the rotor case 310 may include a hub base 312 press-fitted into the upper end of the shaft 110 to thereby be fixed thereto and a magnet support part 314 extended in the outer diameter direction from the hub base 312 and bent downwardly in the axial direction to thereby support the magnet 320 of the rotor 300.

In addition, the rotor case 310 may include the main wall part 316 extended downwardly in the axial direction such that the sealing part sealing the lubricating fluid is provided between the main wall part 316 and the sleeve housing 170.

An interval between the main wall part 316 and the sleeve 120 may be gradually widened upwardly in the axial direction in order to prevent the lubricating fluid from being leaked to the outside at the time of the driving of the motor. To this end, the inner peripheral surface of the sleeve housing 170 corresponding to the main wall part 316 may be tapered in the outer diameter direction. Various examples thereof will be described below with reference to FIGS. 2 and 3.

FIGS. 2A and 2B are schematic cross-sectional views of a hydrodynamic bearing assembly provided in the motor according to the embodiment of the present invention. FIGS. 3A and 3B are schematic cross-sectional views of a hydrodynamic bearing assembly provided in a motor according to another embodiment of the present invention.

Referring to FIG. 2, in the motor according to the embodiment of the present invention, an upper end portion of the sleeve housing 170 may include a mounting part 171 bent outwardly in the outer diameter direction and then bent upwardly in the axial direction to thereby allow the main wall part 316 to be disposed in the inner diameter direction thereof. In this case, the main wall part 316 faces the sleeve 120 inwardly and faces the sleeve housing 170 outwardly.

Here, a shape of the sealing part will be described. The oil passes through a lower surface of the main wall part 316 along an outer peripheral surface of the sleeve 120 from an upper surface of the sleeve 120 to fill the outer peripheral surface of the main wall part 316 and the inner peripheral surface of the sleeve housing 170, such that a oil interface S may be formed between the outer peripheral surface of the main wall part 316 and the inner peripheral surface of the sleeve housing 170 to provide the sealing part. As described above, the sealing part may have a significantly long length in such a manner that the sealing part encloses all of an inner side, a lower surface, and an outer side of the main wall part 316, whereby a sufficient amount of oil 1 may be secured.

That is, the sealing part in which the oil interface S is formed to thereby seal the oil may be understood in FIGS. 2 and 3, which are enlarged views of part “A” of FIG. 1. As shown in part “A”, the sealing part has a significantly long length in such a manner that it encloses the inner side, the lower surface, and the outer side of the main wall part 316, whereby a sufficient amount of oil may be secured.

Here, a clearance between the main wall part 316 and the sleeve housing 170 needs to be widened upwardly in the axial direction in order to form the oil interface. To this end, the outer peripheral surface of the main wall part 316 may be tapered such that an interval between the main wall part 316 and the sleeve housing 170 is widened upwardly in the axial direction (See FIG. 2B) or the inner peripheral surface of the sleeve housing 170 facing the main wall part 316 may be tapered such that the interval between the main wall part 316 and the sleeve housing 170 is widened upwardly in the axial direction (See FIG. 2A).

Referring to FIG. 3, in a motor according to another embodiment of the present invention, the upper end portion of the sleeve housing 170 may include a step part 173 provided on an inner peripheral surface thereof to thereby allow the main wall part 316 to be disposed.

In the embodiment, configurations other than a configuration in which apart provided as the mounting part 171 in the embodiment of FIGS. 2A and 2B is replaced by the step part 173, are the same as those of the embodiment described in FIGS. 2A and 2B. Therefore, a description thereof will be omitted.

In the embodiment, the step part 173 provided to be stepped in the upper end portion of the sleeve housing 170 to thereby allow the main wall part 316 to be disposed may be provided. Even in this case, the sealing part is formed to enclose the inner side, the lower portion, and the outer side of the main wall part 316, such that the sealing part may have a significantly long length.

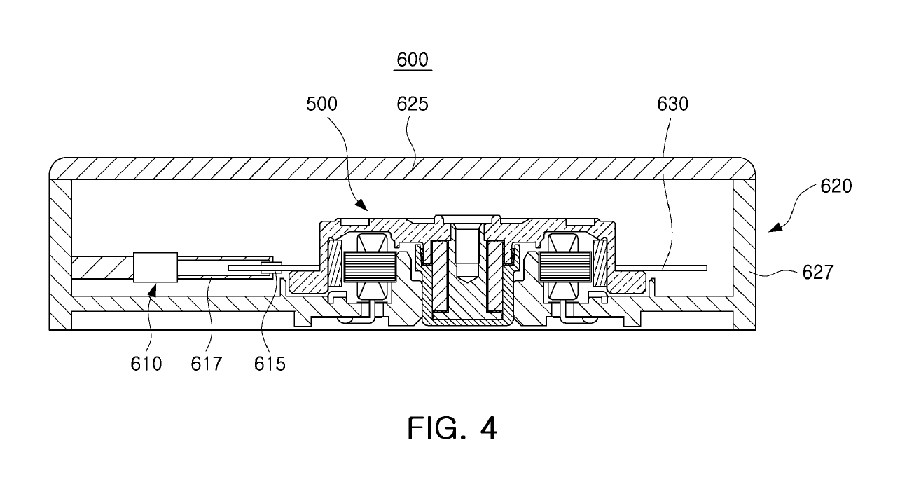

FIG. 4 is a schematic cross-sectional view of a recording disk driving device in which the motor according to the embodiment of the present invention is mounted.

Referring to FIG. 4, a recording disk driving device 600 in which the motor 500 according to the embodiment of the present invention is mounted is a hard disk driving device and may include the motor 500, a head transfer part 610, and a housing 620.

The motor 500 has all the characteristics of the motor according to the embodiment of the present invention described above and may have a recording disk 630 mounted thereon.

The head transfer part 610 may transfer a head 615 detecting information of the recording disk 630 mounted in the motor 500 to a surface of the recording disk on which information is to be detected.

In this case, the head 615 may be disposed on a support member 617 of the head transfer part 610.

The housing 620 may include a motor mounting plate 627 and a top cover 625 shielding an upper portion of the motor mounting plate 627 in order to form an inner space accommodating the motor 500 and the head transfer part 610.

With the hydrodynamic bearing assembly 100 and the motor 500 including the same according to the above-mentioned embodiments of the present invention, the length of the sealing part may be increased to appropriately overcome a limitation in which variations in an oil interface are increased due to the thermal expansion of oil, which is a disadvantage of the sintered sleeve, whereby a stable product may be provided.

As set forth above, with the hydrodynamic bearing assembly and the motor including the same according to the embodiments of the present invention, the length of the sealing part in which the oil interface is formed is increased to cope with a rapid variation in an amount of oil, whereby the performance of the motor could be improved. Further, the leakage of the oil is prevented due to the relatively long sealing part in spite of external impacts, or the like, whereby stability of the motor could be improved.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve supporting a shaft such that an upper end of the shaft protrudes upwardly in an axial direction;
a sleeve housing provided to enclose an outer peripheral surface of the sleeve, and forming an oil interface between an inner peripheral surface thereof in an outer diameter direction and a main wall part protruding downwardly in the axial direction from a rotor case inserted into the upper end of the shaft; and
a cover member provided in lower portions of the shaft and the sleeve and coupled to the sleeve housing while having a clearance therebetween.

2. The hydrodynamic bearing assembly of claim 1, wherein an upper end portion of the sleeve housing includes a mounting part bent outwardly in the outer diameter direction and then bent upwardly in the axial direction to thereby allow the main wall part to be disposed.

3. The hydrodynamic bearing assembly of claim 1, wherein an upper end portion of the sleeve housing includes a step part provided on an inner peripheral surface thereof to thereby allow the main wall part to be disposed.

4. The hydrodynamic bearing assembly of claim 1, wherein an outer peripheral surface of main wall part is tapered such that an interval between the main wall part and the sleeve housing is widened upwardly in the axial direction.

5. The hydrodynamic bearing assembly of claim 1, wherein the inner peripheral surface of the sleeve housing facing the main wall part is tapered such that an interval between the main wall part and the sleeve housing is widened upwardly in the axial direction.

6. The hydrodynamic bearing assembly of claim 1, wherein the sleeve housing and the cover member are formed integrally with each other.

7. The hydrodynamic bearing assembly of claim 1, further comprising a thrust plate mounted on the lower portion of the shaft and facing a lower surface of the sleeve in the axial direction.

8. The hydrodynamic bearing assembly of claim 1, wherein a thrust dynamic groove is provided in an upper surface of the sleeve or in a lower surface of the rotor case facing the sleeve.

9. The hydrodynamic bearing assembly of claim 7, wherein a thrust dynamic groove is provided in a lower surface of the sleeve or in an upper surface of the thrust plate.

10. The hydrodynamic bearing assembly of claim 1, wherein the sleeve is a sintered sleeve.

11. A motor comprising the hydrodynamic bearing assembly of claim 1.
